(19) United States
(12) Patent Application Publication
(10) Pub. No.: US 2011/0246194 A1
(43) Pub. Date: Oct. 6, 2011

(54) Indicia to indicate a dictation application is capable of receiving audio

(75) Inventors: Rebecca Heins, Boulder, CO (US); Edward Kizhner, Frederick, CO (US)

(73) Assignee: nVoq Incorporated, Boulder, CO (US)

(21) Appl. No.: 12/749,889

(22) Filed: Mar. 30, 2010

(51) Int. Cl. G10L 15/26; G06F 3/048

(52) U.S. Cl. 704/235; 715/823; 704/E15.043

(57) ABSTRACT

A client station having access to an application is provided. The application has at least one indicia having a first configuration and a second configuration different from the first configuration. The second configuration indicating the application is able to accept input.

### CLAIM OF PRIORITY UNDER 35 U.S.C. §119

None.

### CLAIM OF PRIORITY UNDER 35 U.S.C. §120

None.

### REFERENCE TO CO-PENDING APPLICATIONS FOR PATENT

None.

### BACKGROUND

1. Field

The technology of the present application relates generally to activating or invoking an application in a computerized work environment, and, more specifically, to providing an indicia that an activated application is ready to accept input.

2. Background

Computers and processors are a ubiquitous tool today. Many common personal and business applications are completed using everyday computers and processors, such as, for example, desktop computers, laptop computers, MP3 players, electronic personal digital assistants, smartphones, and the like. Applications, however, are typically developed using state of the art computers and processors. Users, however, frequently do not have the most up-to-date computers and processors. Thus, the applications are often designed for computers and processors that have more capacity than the processor or computer on which the application is launched and run. The lower capacity computer or processor may be able to execute the application, but the execution introduces processing delays in the form of lag and latency.

Additionally, many applications today are executed on computers or processors using a thin client architecture. A thin client architecture is one in which a user operates a client computer that provides an interface, such as a graphical user interface, but the actual processing of the application is performed by a host computer connected to the client computer via a network connection. The network connection may be, for example, the World Wide Web or another public network, or a proprietary network. The transfer of data, whether a batch transfer or a streaming transfer, may introduce additional lag or latency delays. Delays in the form of lag and latency associated with thin client applications may be exacerbated by older computers and processors that lack sufficient processing speeds and capacity.

In many instances, the lag and latency are little more than a nuisance in usability in that data is not lost, but simply cached in a buffer for eventual processing when the computer or processor has available capacity. In some applications, however, the computer or processor is not able to receive required data until the application is activated or a specific operation is invoked. This is especially true for speech dictation. In particular, the lag or latency between sending a command when a dictation application is invoked and the computer or processor being capable of receiving audio may be significant. If the user begins speaking, for example, before the computer, processor, or recording equipment is ready to receive audio data, a portion of the data will be lost. Thus, against this background, it would be desirous to provide indicia that the launched application is in a state ready to receive input.

### SUMMARY

A computer-implemented method for providing an indication that an application is capable of receiving data is described. An instruction is provided to the processor to activate or invoke the application. The processor fetches the application from memory and executes the commands to activate or invoke the application. Indicia regarding the status of the application is provided in a first configuration indicating that the application is being activated or invoked but is not yet capable of accepting data. Once the application is active and capable of receiving data, the indicia regarding the status of the application is provided in a second configuration, different from the first configuration, indicating that the application is active and ready to receive data.

In one configuration, the indicia may be a microphone image indicative of recording audio via an actual microphone. The microphone may comprise a first color, such as, for example, RED to indicate to the user that the application is not yet capable of receiving audio. The microphone may comprise a second color, such as, for example, GREEN to indicate to the user that the application is now capable of receiving audio. The red and green indicia signal to a user when spoken audio will be recorded and transcribed.

In another configuration, the indicia may be an audio playback of a file indicative of recording audio via an actual microphone. The playback of the audio file may be a particular sound when the application is capable of receiving audio signals.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the technology of the present application.

FIG. 1 is an exemplary embodiment of a graphical user interface having indicia configured to visually indicate that an application is not ready to accept data where the indicia is in a first configuration;

FIG. 2 is an exemplary embodiment of a graphical user interface having indicia configured to visually indicate that an application is ready to accept data where the indicia is in a second configuration;

FIGS. 3A and 3B show a visual indicia associated with the technology of the present application;

FIG. 4 is an exemplary flowchart illustrating operational steps associated with the technology of the present application; and

FIG. 5 is a functional block diagram of an exemplary computer having an operating system consistent with the technology of the present application.

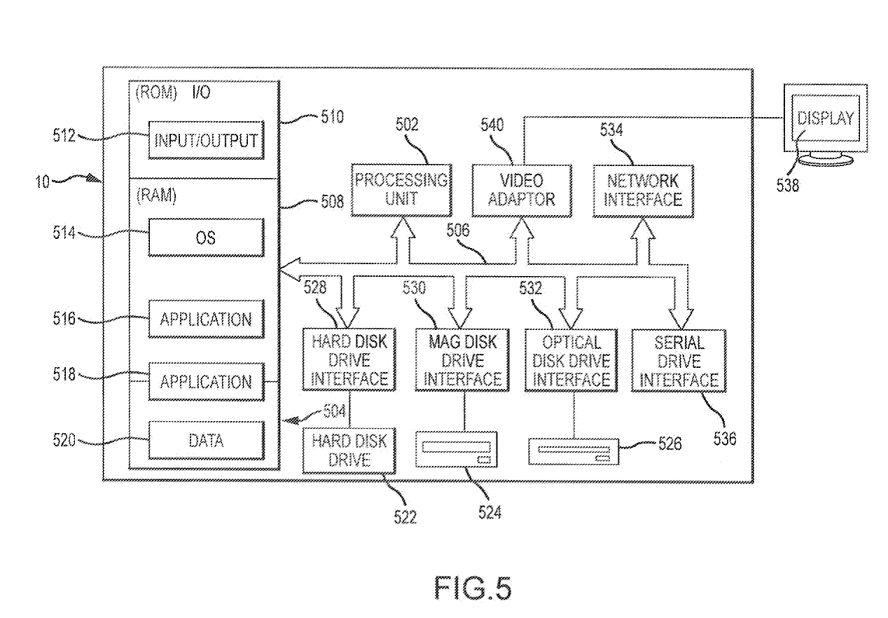

Throughout the drawings, identical reference characters and descriptions indicate similar, but not necessarily identical elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The technology of the present application will now be explained with reference to a dictation or recording application where the data being received by the application is audio. The technology, in general, is described as receiving audio from a user as the data input, but the technology of the present application would be useful for data other than audio. Moreover, the technology of the present application is explained using a conventional operating system, such as, for example, WINDOWS®, that is available from Microsoft Corporation. One of ordinary skill in the art on reading the disclosure will now recognize that the technology of the present application will be useful in other environments and other operating systems. Other operating systems include, for example, Linux, Mac OS X, Solaris, to name but a few conventional operating systems. Moreover, while described as operating on a thin client, the technology of the present application also is useful using a fat client. A thin client would use a remote server or other processor to run the application being accessed by the thin client instead of the local processor as in a fat client. Additionally, the technology of the present application may be especially useful for automated transcription of dictation as an automated transcribing engine is less able to “guess” clipped or otherwise unrecorded audio. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

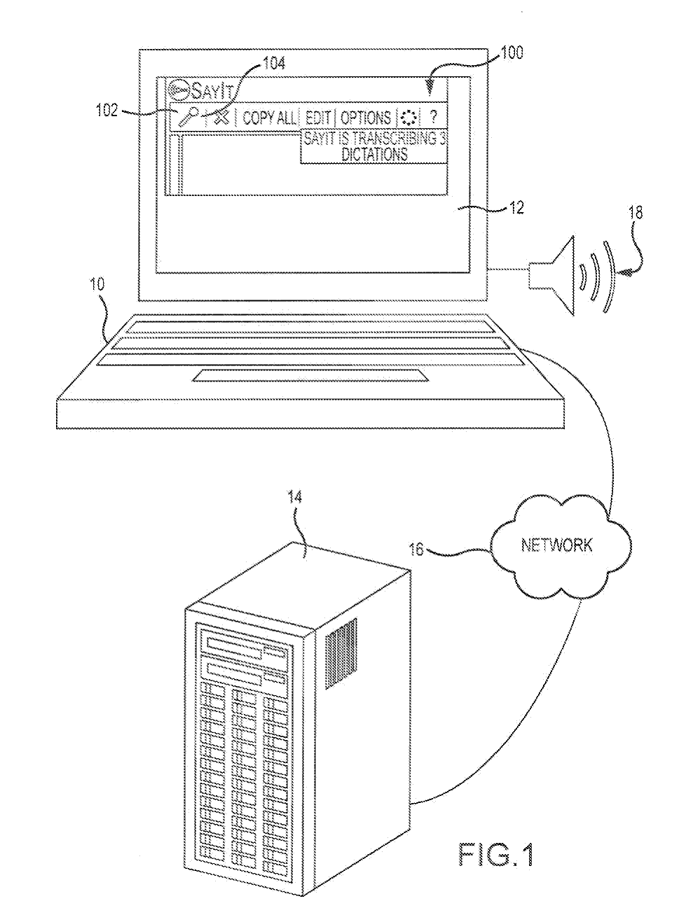

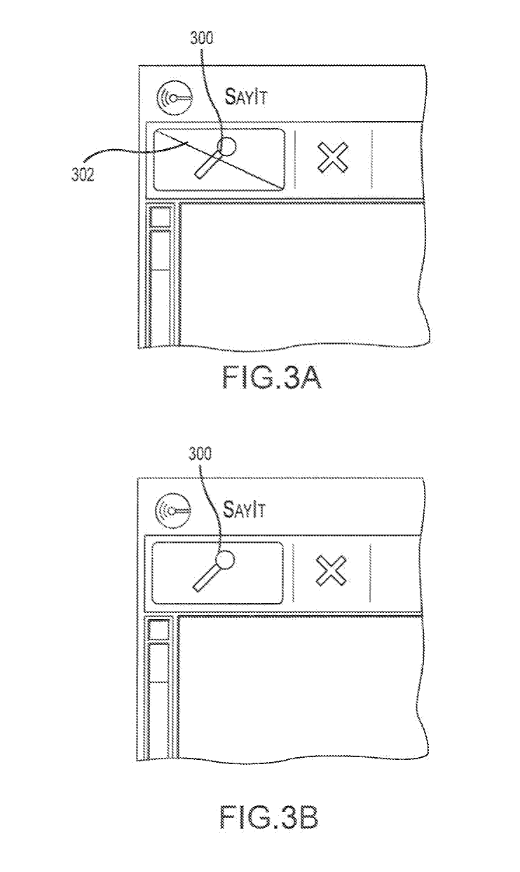

Referring first to FIG. 1, a portion of a graphical user interface 100 is shown. A graphical user interface is displayed on a display 12 of a computer 10 or the like. Computer 10 may be a conventional desktop or laptop computer. The technology of the present application is described as it relates to a thin client customer operating system, such as may reside on the computer 10 that is connected to a remote server 14 through a communication network 16. As mentioned above, the communication network 16 may in certain embodiments be a public communication network 16 such as, for example, the Internet, the World Wide Web, other packet based networks, cellular networks, wireless networks, such as, for example, WiFi and WiMax networks, other local area networks, wide area networks, a wireless local area network, an Ethernet connection, a public switch network, a PSTN network, or the like. For this exemplary embodiment, the graphical user interface 100 has an exemplary graphical icon 102 in a tool bar in the shape of a microphone in a first configuration 104 indicative that the application is not ready for accepting audio. In this instance, the indicia is a color on the microphone indicating the system is not ready to accept audio signals. The color is currently contemplated to be RED, which is indicative of stop. Other colors could, of course, be used. Alternative indicia also may be provided. For example, as shown in FIG. 3A, the microphone graphic 300 may be provided with a line 302 over the microphone indicative of a commonly accepted visual for “NO,” which would indicate no microphone is currently available.

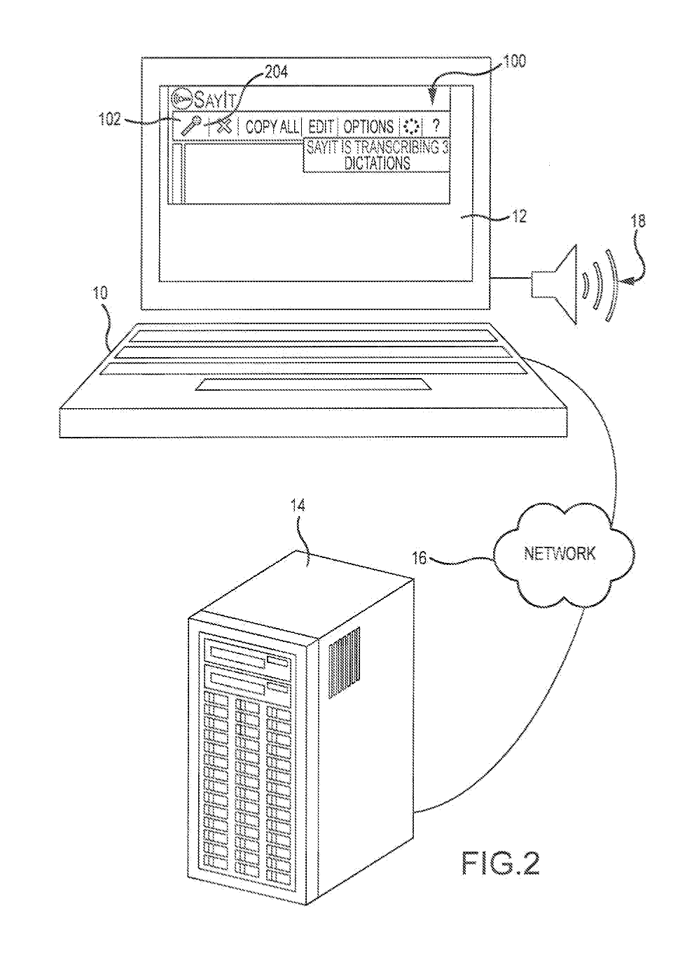

Referring now to FIG. 2, FIG. 2 is similar to FIG. 1, but graphic icon 102 of the microphone has been activated and the underlining program accessible through the graphical user interface 100 has been activated. Thus, graphic icon 102 is provided in a second configuration 204. In this exemplary embodiment, the second configuration 204 of the graphical icon 102 is contemplated to be a GREEN microphone, which is indicative of go. Other visual indicators are also possible instead of, for example, color. Referring to FIG. 3B, the microphone 300 is shown without the line 302 over the microphone. Other visual indicators may include, for example, a smaller and larger visual of the graphical icon, an “X” or “O”, an “ON” or “OFF”, a flip switch, or the like.

While a visual indication is currently contemplated, the visual indication may be replaced with a sound emanating from a speaker 18 attached to computer 10. For example, when the graphical icon 102 was operated, such as by clicking the graphical icon, speaker 18 may provide a first sound indicative that the microphone is not yet available as the application is fetched and activated. Once activated and ready, speaker 18 would provide a second sound or audible indicative that the microphone is now available. The first and second sounds may be the same or different. For example, a first electronic chirp may indicate that the application function is being activated or invoked, but the application is not yet ready to receive audio. A second electronic chirp may indicate that the application function has been activated, and the application is ready to receive data. Alternatively, the first sound may be a continuous sound or continuous string of electronic chirps indicating that the application is not yet ready to receive audio; whereas the second sound may be a change or ending of the continuous sound or continuous string of electronic chirps indicating the application is now ready to receive audio. Alternatively, the first sound may be an electronic chirp and the second sound may be an electronic bell, etc.

While the present application may be useful for several types of data entry, it is particularly useful for audio applications and applications operating in conjunction with a graphical user interface such that the applications are activated or invoked and operating within other applications. For example, with dictation, a user may click a graphical icon to activate a dictation/transcription program, such as, for example DRAGON® NATURALLYSPEAKING® available from Nuance Communications Corporation. The person may begin speaking into the microphone immediately following clicking the graphical icon to activate the program, substantially simultaneously with clicking the graphical icon, or even in some situations prior to clicking the graphic icon. However, the dictation/transcription program is not yet completely activated and ready to accept audio input. Thus, the audio spoken while the program is activating is not recorded, not transcribed, and potentially, not recoverable.

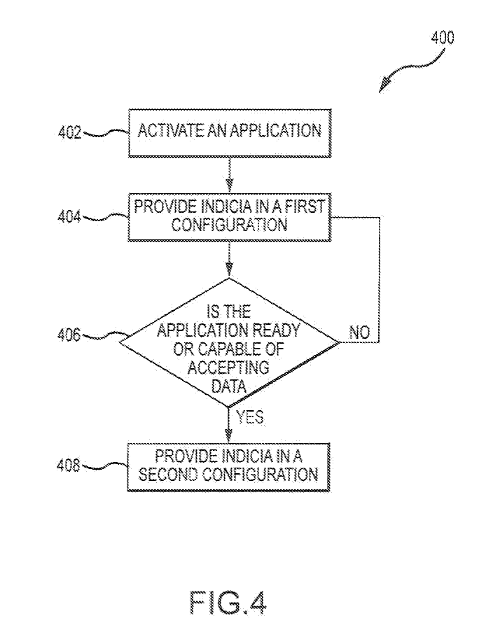

FIG. 4 provides a flowchart 400 indicative of an exemplary method to provide indicia of when a program is ready to accept data. While flowchart 400 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, the process begins at step 402 by a user activating an application. The activation step may be any conventional means of activating an application as is conventionally known in the art, but is typically, “clicking” on a representative graphical icon associated with the application. In the above exemplary embodiments, the user would, for example, click on graphical icon 102. Indicia associated with the idle state of an application would be provided in a first, initial, or idle configuration, step 404. In one of the above described embodiments, for example, the graphical icon 102 is provided in a first or idle configuration 104 as having a RED color. The RED color would be to indicate that the application is not capable of receiving input and the user of, for example, the dictation/transcription application should not begin speaking. Computer 10 would activate the application, possibly fetching and activating the application if this is the initial use. As described above, computer 10 may be a thin client station such that the computer 10 accesses the remote server 14. Next, it is determined when the activated application is ready to accept data, step 406. If the activated application is not ready to accept data, control returns to step 404. If, however, it is determined the activated application is ready or capable of accepting input, the graphical icon 102 is provided in a second configuration 204 as having a GREEN color, step 408. For example, the last instruction of the activated program associated with dictation/transcription may be to update the display 12 of computer 10 to show the graphical icon 102 in the second configuration 204. In some instances, the indication that the application is capable of accepting audio may be provided subsequently to the point in time when the application is fully active.

Computer 10, as explained above, may be a thin client. However, computer 10 may also be a fat client capable of its own processing. In any event, computer 10 will be described with reference to an exemplary operating system capable of implementing the technology of the present application. Generally, computer 10 includes a processing unit 502, a system memory 504, and a system bus 506. System bus 506 couples the various system components and allows data and control signals to be exchanged between the components. System bus 506 could operate on any number of conventional bus protocols. System memory 504 generally comprises both a random access memory (RAM) 508 and a read only memory (ROM) 510. ROM 510 generally stores a basic operating information system such as a basic input/output system (BIOS) 512. RAM 508 often contains the basic operating system (OS) 514, application software 516 and 518, and data 520. Computer 10 generally includes one or more of a hard disk drive 522, a magnetic disk drive 524, or an optical disk drive 526. The drives are connected to the bus 506 via a hard disk drive interface 528, a magnetic disk drive interface 530 and an optical disk drive interface 532. Application modules and data may be stored on a disk, such as,. for example, a hard disk installed in the hard disk drive (not shown). Computer 10 also may have network connection 534 to connect to a local area network (LAN), a wireless network, an Ethernet, or the like, as well as one or more serial port interfaces 536 to connect to peripherals, such as a mouse, keyboard, modem, or printer. Computer 10 also may have USB ports or wireless components, not shown. Computer 10 typically has a display or monitor 538 connected to bus 506 through an appropriate interface, such as a video adapter 540. Monitor 538 may be used as an input mechanism using a touch screen, a light pen, or the like. On reading this disclosure, those of skill in the art will recognize that many of the components discussed as separate units may be combined into one unit and an individual unit may be split into several different units. Further, the various functions could be contained in one personal computer or spread over several networked personal computers.

If computer 10 is connected to a network, typically one or more remote network servers exist to manage the network resources. The network server may be another computer (or computer 10 could act as the server), a server, or other equivalent device.

Those of skill in the art would understand that information and signals may be represented using any of a variety of different technologies and techniques. For example, data, instructions, commands, information, non-transitory signals, bits, symbols, and chips that may be referenced throughout the above description may be represented by non-transitory voltages, non-transitory currents, non-transitory electromagnetic waves, non-transitory magnetic fields or particles, non-transitory optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules: circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method for providing indicia to a dictation client that a dictation application is able to receive data input, comprising:
initiating a dictation application that uses audio input received from a microphone at a client station;
indicating at the client station through the use of at least one indicia having a first configuration that the microphone is not capable of accepting audio input;
determining whether the microphone at the client station is capable of receiving audio input for the dictation application; and
if it is determined in the determining step that the microphone at the client station is capable of receiving audio input for the dictation application, transforming the at least one indicia from the first configuration to a second configuration indicating that the microphone is capable of accepting audio input.

2. The method of claim 1 wherein the initiating step comprises clicking a graphical icon and the at least one indicia having a first configuration is the clicked graphical icon.

3. The method of claim 2 wherein the first configuration comprises a first color.

4. The method of claim 3 wherein the second configuration of the at least one indicia is the graphical icon having a second color different from the first.

5. The method of claim 2 wherein the first configuration is a line through the graphical icon and the second configuration of the at least one indicia is the graphical icon without the line through the graphical icon.

6. The method of claim 2 wherein the first configuration is a first size of the graphical icon and the second configuration of the at least one indicia is the graphical icon having a second size different from the first size.

7. The method of claim 1 wherein the at least one indicia having a first configuration comprises a first tone and the at least one indicia having a second configuration comprises a second tone different from the first tone.

8. The method of claim 1 wherein at least one of the first tone or the second tone is silence.

9. An apparatus comprising:
a processor; and
a display;
the display providing a graphical user interface having a tool bar with at least one graphical icon indicative of an application accessible through the graphical user interface;
the display providing a first indicia having a first configuration and a second configuration, the first configuration indicating the application is not capable of receiving input and the second configuration indicating the application is capable of receiving input, the first configuration being different than the second configuration; and
the processor to initiate the application when the at least one graphical icon is activated and the processor to cause the first indicia to be in the first configuration, the processor having a determination module to determine when the application is capable of receiving input and, when it is determined the application is capable of receiving input, to cause the first indicia to be in the second configuration indicating the application is capable of receiving input.

10. The apparatus of claim 9, wherein the application is a dictation application and the application is capable of receiving input when the microphone is capable of transmitting audio data to the application.

11. The apparatus of claim 10, wherein the first indicia is a graphical icon.

12. The apparatus of claim 11, wherein the first configuration is displaying the graphical icon in a first color and the second configuration is displaying the graphical icon in a second color different from the first.

13. The apparatus of claim 12 wherein the graphical icon is a microphone.

14. The apparatus of claim 10, wherein the first indicia is an audible tone and the first configuration is a first tone and the second configuration is a second tone wherein the second tone is different from the first tone.

15. The apparatus of claim 14, wherein at least one of the first tone and the second tone is silence.

16. A dictation/transcription system, comprising:
at least one processor, the at least one processor comprising a speech recognition engine that converts audio data to textual data;
a display coupled to the at least one processor, the display having a graphical user interface to allow the user to provide instructions to the at least one processor; and
a microphone coupled to the at least one processor, the microphone to receive audio input from a user and provide audio data to the at least one processor for the speech recognition engine to convert to textual data; wherein
the processor displays on the graphical user interface a first graphical icon having a first configuration indicating the microphone is not able to provide audio to the speech recognition engine and having a second configuration indicating that the microphone is able to provide audio to the speech recognition engine.
